(19) United States
(12) Patent Application Publication
(10) Pub. No.: US 2003/0214816 A1
(43) Pub. Date: Nov. 20, 2003

(54) Indicating light

(76) Inventors: Reinhold Barlian, Bad Mergentheim (DE); Karl-Heinz Lux, Weikersheim (DE)

Correspondence Address: Horst M. Kasper, 13 Forest Drive, Warren, NJ, 07059, US

(21) Appl. No.: 10/387,817

(22) Filed: Mar. 13, 2003

(30) Foreign Application Priority Data
Mar. 13, 2002 (DE) 102 10 984.2

(51) Int. Cl. F21V 7/04

(52) U.S. Cl. 362/555

(57) ABSTRACT

Indicating light for an optical display, with a housing exhibiting electrically conductive parts, a light-emitting diode, and a push element, capable of axial displacement in a hollow rod, for a switch mounted in the hollow rod.

The invention relates to a indicating light for an optical display.

Known indicating lights exhibit a housing, a light display, and an electrical switch mechanism, which is arranged offset laterally in the housing or located externally on the housing, and is capable of actuation by axial displacement of the light display.

The problem of the invention consists of providing a indicating light which is capable of being manufactured with simple means as a compact structural unit, and has a high level of functional reliability.

This problem is resolved according to the invention by the features of claim 1.

Preferred embodiments and further embodiments of the invention are characterised by the features of the sub-claims.

Further advantages and major details of the invention can be derived from the following Description and the drawings, which in a diagrammatic representation show preferred embodiments by way of examples. These show:

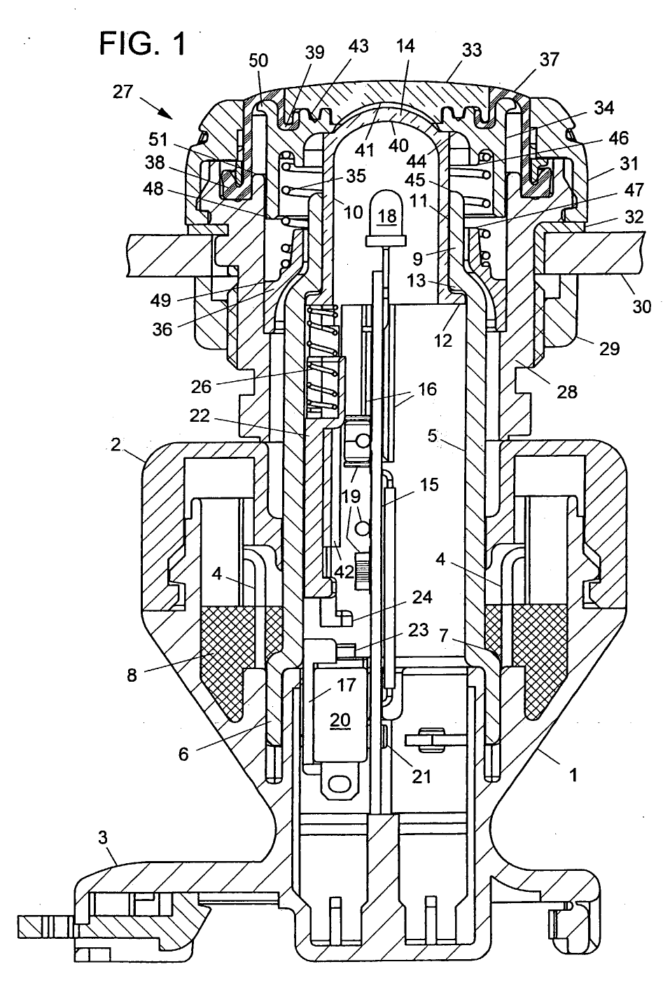

FIG. 1 A indicating light according to the invention in an enlarged plan view, partially sectioned,

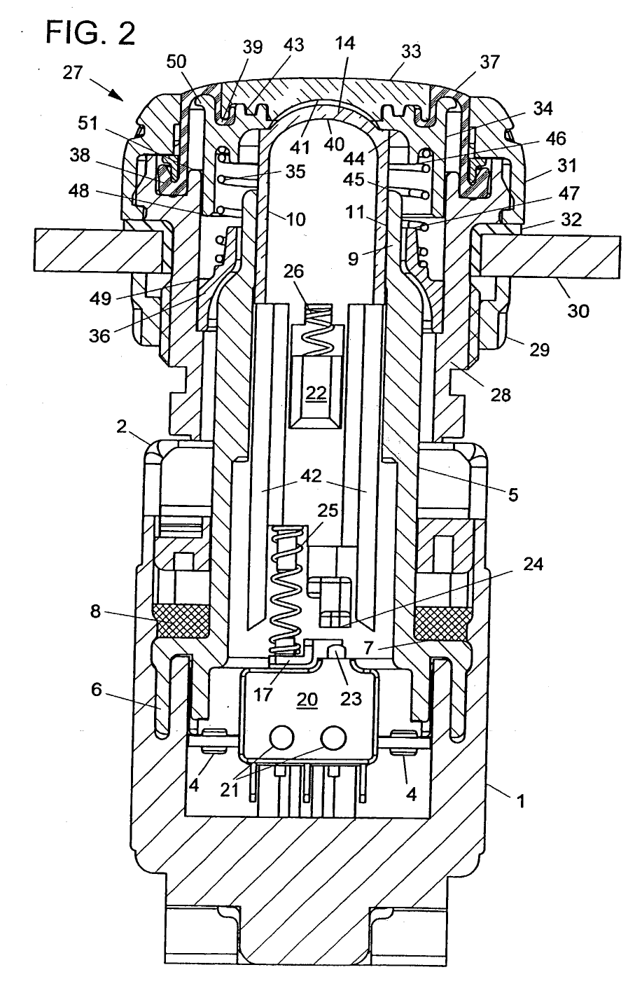

FIG. 2 The indicating light from FIG. 1 in a plan view rotated through 90°, partially sectioned, and

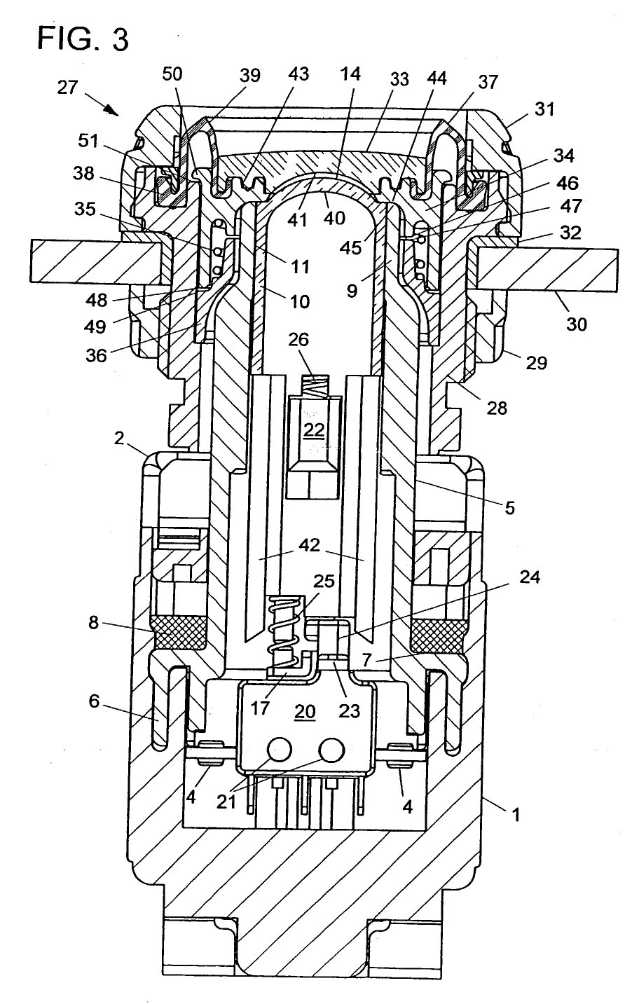

FIG. 3 The indicating light from FIG. 2 with a push element depressed axially.

The indicating light exhibits a housing 1 with a cover 2 and a foot piece 3, which is capable of being secured to a profile rail, not shown here. Located in the housing are electrically conductive parts 4 for the connection of electrical infeed and outfeed lines and connection terminals, likewise not represented.

Located in the housing 1 is also a hollow rod 5, which is designed essentially as a rod which is cylindrically circular in cross-section, which passes through the cover 2 and has a rectangular shaped rod end piece 6 at the bottom, which is secured in a housing 1 and of which the rectangular dimensions are somewhat greater than the diameter of the adjacent part of the hollow rod 5. At the beginning of the rod end part 6, a shoulder 7 is formed because of the greater rectangular dimension. In this area the hollow rod 5 is surrounded by a casting of artificial resin 8 introduced into the housing 1, this casting engaging around the shoulder 7. The cast resin casting 8 is designed in such a way that it accords with the standardised requirements of explosion protection according to DIN EN 50014/18/19.

The end area 9 of the hollow rod 5 located away from the rod end piece 6 has a diameter which is somewhat smaller than the middle section of the hollow rod 5. Mounted in the end area 9 is an axially displaceable push element 10, arranged in such a way that between the inner surface of the end section 9 and the outer surface of the push element 10 a standardised explosion protection gap 11 is formed in accordance with DIN EN 50014/18.

The push element 10 exhibits lugs 12, which come in contact with a stop 13 formed by the cross-section narrowing of the end area 9. On the side located away from the lugs 12 the push element 10 is enclosed by a hemispherically-shaped translucent round head 14. The push element 10 can to the purpose be manufactured of uniform material and as one piece with the lugs 12 and the translucent round head 14, made of a translucent material. For use in areas subject to the risk of explosion, the hollow rod 5, with the push element 10 and the housing 1, can be designed as a pressure-resistant capsule in accordance with the requirements of explosion protection.

A printed circuit board 15 can be mounted in the hollow rod 5, which for preference is fixed between web-shaped retaining ribs 16 and a mounting bracket 17. The printed circuit board 15 carries a light-emitting diode 18, which is located at the level of the end area 9 inside the push element 10 at a distance interval beneath the translucent round bead 14 and is aligned towards this. In addition, electronic components 19 serving the function of the light-emitting diode 16 can be arranged on the printed circuit board 15.

In addition to this, an electric switch 20 can be arranged in the hollow rod 5 in the area of the rod end part 6, which is likewise mounted on the mounting bracket 17. For preference the mounting bracket 17 can also exhibit two gudgeons 21, which engage in corresponding holes of the switch 20 and the printed circuit board 15. The mounting bracket 17 itself can likewise be positioned in the hollow rod 5 and fixed in position by means of the electrical conductor parts 4. In order to be able to actuate the switch 20 when the push element 10 is pushed in, a contact element 22 is provided inside the hollow rod 5 between the push element 10 and the switch 20, which can be displaced in the longitudinal direction of the hollow rod 5 against a tappet 23 of the switch 20. The switch element 22 can be mounted on guide rails 42 and be provided with a switch bolt 24, which corresponds to the tappet 23. To the purpose, a pressure spring 25 is allocated to the switch element 22, which is supported inside the hollow rod 5 on the mounting bracket 17, and has the effect that the switch element 23 and the push element 10 located above it are pushed upwards, i.e. away from the tappet 23. In addition to this, an over-stroke spring 26 is provided, which is arranged between the push element 10 and the switch element 22. Accordingly, all electrical technically relevant light and switching components, such as the light-emitting diode 18, printed circuit board 15, components 19, switch element 22, pressure spring 25, over-stroke spring 25 and switch 20, are arranged in a space-saving arrangement behind one another and in part also next to one another, mounted exclusively inside the pressure-resistant encapsulated area of the tubular hollow rod 5.

As can also be derived from the drawing, the indicating light can exhibit an operating attachment 27, which engages over the part of the hollow rod 6 projecting out of the cover 2 and the pressure element 10. The actuating attachment 27 exhibits an insertion housing 28 surrounding the hollow rod 5 in tubular fashion, with a threaded nut 29, and can be secured to a mounting wall 30, which is mounted between the threaded nut 29 and a front ring 31, whereby a sealing ring 32 can be provided between the perforated edge of the mounting wall 30 and the insertion housing 28, as well as the front ring 31. The threaded nut 29 rotatably mounted on the insertion housing 28 is in this situation screwed against the inner side of the mounting wall 30, so that the actuating attachment 27 is mounted in a locationally-secure manner.

In addition to this, the actuating attachment 27 exhibits a translucent light cap 33, which engages over the light cap 14 of the push element 10. The light cap 33 is part of an adaptor sleeve 34, which in turn is part of the push element 10, so that, in the event of a switch actuation, both the push element 10 and the light cap 33 with the adaptor sleeve are displaced axially. The adaptor sleeve 34 is supported by a support spring 35 designed as a pressure spring, which is supported on a sleeve 36. In order to achieve a tight seal upwards at the actuating attachment 27, a moulded seal 37 can be provided, which is mounted with a seat 36 in a groove of the insertion housing 28, and is retained by means of the front ring 31. As can be seen from the drawing, the peripheral areas of the light cap 33 and the adaptor sleeve 34 are engaged and sealed by a collar 39 of the moulded seal 37, whereby the sealed system pertains at the collar 39 after the connection of the tongue-and-groove segment 43. This connection can, to the purpose, be created by adhesive bonding or by ultrasonic welding.

In the printed circuit board (FIG. 3) the push element 10 with the light cap 33 and the adaptor sleeve 34 is pressed against the force of the support spring 35 axially downwards, and specifically sufficiently far for a contact surface 44 of the adaptor sleeve 34 to come in contact with the face surface 45 of the end area 9 of the hollow rod 5, so that a secure support arrangement is provided, in that a downwards-pointing peripheral surface 46 of the adaptor sleeve 34 is in contact with an upwards-pointing annular surface 47 of the sleeve 36, a downwards-pointing end surface 48 of the adaptor sleeve 34 lies on a circular surface 49 of the sleeve 36, and a lug 50 of the adaptor sleeve 34 comes in contact with an upwards-pointing web surface 51 of the insertion housing 28. As a result of this, a four-fold support is provided at push actuation, so that even high impact forces can be reliably absorbed and no mechanical damage can be incurred.

In the pressed switch position, the switch element 22 is displaced against the force of the pressure spring 25 so far downwards that the tappet 23 is pressed right inwards by the switch bolt 24 in order to actuate the switch 20. In addition, it can be seen from FIG. 3 that the over-stroke spring 25 is also compressed somewhat in relation to the representation in FOG. 2, so that no rigid forces take effect on the switch 20, and this therefore also cannot be damaged.

In order to achieve a uniform and bright illumination, it may be of advantage for at least the hemispherical inner surface 40 of the light cap. 14 of the push element 10, turned towards the light-emitting diode 18, to be designed in such a way that a fine-beaded structure is exhibited. The inside surface 40 can therefore have a plurality of small spherical or bead-shaped elevations and a plurality of small depressions, arranged alternately directly next to one another, so that the inside surface 40 is not smooth but finely roughened. Such a finely roughened inside surface structure can to advantage be produced by erosion, etching, shot-blasting, or by a corresponding arrangement of the mould surface. The finely-roughened inside surface structure has the effect that the light emitted by the light-emitting diode 16 breaks and is caught on the entire inside surface 40 of the light cap 14 in such a way a uniformly great lighting body lights up. In addition to this, it is also of advantage for the pressure element 10 overall, but at least the light cap 14, to be coloured in a diffuse milky or milk-coloured fluorescent manner. By way of such a colouration, the light permeability is reduced in such a manner that, with the light-emitting diode 18 switched on, a certain inherent lighting of the pressure element 10 and of the light cap 14 respectively occurs, as a result of which the lighting effect is even more uniform and intensive.

Like the light cap 14, the light cap 33 also consists of a translucent material and covers the light cap 14 at a brief distance interval. The inner side 41 of the light cap 33 turned towards the light cap 14 can likewise have a fine-beaded structure. This structure can be designed in such a way that a plurality of small bead-shaped elevations and a plurality of small depressions are located alternating directly next to one another, so that the inside surface 41 is finely roughed. This finely-roughed inside surface structure can essentially be designed in the same way as the finely-roughed inside surface structure of the light cap 14, and manufactured in accordance with the same production process. In addition to this, it can also be of advantage for the light cap 33 to be coloured in a diffuse milky fashion or in a milky fluorescent manner, in order for the light permeability to be reduced, as a result of which an inherent lighting of the light cap 33 and a uniform and more intensive lighting is achieved. An optimally bright and uniform lighting can also be achieved in that both the light cap 14 of the pressure element 10, as well as the light cap 33 of the actuating attachment 27, are coloured in accordance with the light or colour wavelength of the light-emitting diode 18.

1. Indicating light for optical display, comprising a housing (1) with electrical conductor parts (4), a light-emitting diode (18) in a push element (10) which has a translucent round head (14), a hollow rod (5) within the end area (9) of which the push element (10) is axially moveably located and the other end piece (6) of which is arranged in the housing (1), and an electrical switch (20) which is arranged in the hollow rod (5), in its longitudinal direction behind the light-emitting diode (18), and is operable by axial movement of the push element (10).

2. Indicating light according to the preceding claim, characterised in that a contact element (22) can be moved against a tappet (23) of the switch (20) is arranged between the push element (10) and the switch (20).

3. Indicating light according to one of the preceding claims, characterised in that the contact element (22) and the push element (10) are supported at a thrust spring (25) positioned in the housing (1).

4. Indicating light according to one of the preceding claims, characterised in that an overrun spring (26) is provided between the push element (10) and the contact element (22).

5. Indicating light according to one of the preceding claims, characterised in that the bush button piece (10) is supported by lugs (12) at a stop (13) in the hollow rod (5).

6. Indicating light according to one of the preceding claims, characterised in that part of the hollow rod (5) is cast over in the housing (1) with moulding resin (8) according to the explosion protection requirements.

7. Indicating light according to one of the preceding claims, characterised in that an explosion protection gap (11) conforming to standards is formed between the inner face of the hollow rod (5) and an outer face of the push element (10) axially movable in the latter.

8. Indicating light according to one of the preceding claims, characterised in that the hollow rod (5) with the push element (10) and the housing (1) is designed as a pressure-tight capsule conforming to explosion protection standards.

9. Indicating light according to one of the preceding claims, characterised in that the housing (1) is closed by a cover (2) into which the hollow rod (5) protrudes.

10. Indicating light according to one of the preceding claims, characterised in that a printed circuit board (15) with the light-emitting diode (18) and electronic components (19) arranged on it is provided within the hollow rod (5).

11. Indicating light according to one of the preceding claims, characterised in that the switch (20) and/or the printed circuit board (15) are positioned at a mounting bracket (17).

12. Indicating light according to one of the preceding claims, characterised in that the mounting bracket (17) has at least one pin (21) passing through the switch (20) and engaging the printed circuit board (15).

13. Indicating light according to one of the preceding claims, characterised in that the mounting bracket (17) is positioned in the hollow rod (5) and fixed in position by means of the conductor part (4)

14. Indicating light according to one of the preceding claims, characterised in that an operating attachment (27) extends over the part of the hollow rod (5) which protrudes past the cover (2) of the housing (1).

15. Indicating light according to one of the preceding claims, characterised in that the operating attachment (27) is attachable to a mounting wall (30) which is arranged between a front ring (31) and a threaded nut (29) located at an insert housing (28).

16. Indicating light according to one of the preceding claims, characterised in that the operating attachment (27) has a translucent light cap (33) extending over the round head (14) of the push element (10).

17. Indicating light according to one of the preceding claims, characterised in that the light cap (33) is arranged at an adaptor sleeve (34) which is associated with the push element (10) and axially movable with it.

18. Indicating light according to one of the preceding claims, characterised in that the adaptor sleeve (34) has an associated supporting spring (35) which is supported at a seat (36).

19. Indicating light according to one of the preceding claims, characterised in that the adaptor sleeve (34) and the light cap (33) rest at a moulded seal (37) when the push element (10) is at rest.

20. Indicating light according to one of the preceding claims, characterised in that, to limit the push button operating stroke, the adaptor sleeve (34) has at least one stop face (44) corresponding to an end face (45) of the end section (9) of the hollow rod (5)

21. Indicating light according to one of the preceding claims, characterised in that a multiple support with an additional edge face (46) annular face (47), end face (48), shoulder face (49), stay face (51) and a lug (50) is provided for limiting the push button operating stroke.

22. Indicating light according to one of the preceding claims, characterised in that the moulded seal (37) is held at the insert housing (28) by means of the front ring (31).

23. Indicating light according to one of the preceding claims, characterised in that the inner side (40) of the round head (14) of the push element (10) facing the light-emitting diode (18) has a refractive fine pearl structure.

24. Indicating light according to one of the preceding claims, characterised in that at least the round head (14) of the push element (10) has a milky tint.

25. Indicating light according to one of the preceding claims, characterised in that at least the round head (14) of the push element (10) has a milky/coloured fluorescent tint.

26. Indicating light according to one of the preceding claims, characterised in that the push element (10) is formed in one piece with the round head (14) and is made from the same material.

27. Indicating light according to one of the preceding claims, characterised in that the inner side (41) of the light cap (33) facing the round head (14) of the push element (10) has a refracting fine pearl structure.

28. Indicating light according to one of the preceding claims, characterised in that the fine pearl structure of the inner side (40) of the round head (14) and the fine pearl structure of the inner side (41) of the light cap (33) are essentially identical.

29. Indicating light according to one of the preceding claims, characterised in that the round head (14) of the push element (10) and the light cap (33) are tinted to suit the wavelength of the light-emitting diode (18).
